(19) United States
(12) Patent Application Publication
(10) Pub. No.: US 2010/0318557 A1
(43) Pub. Date: Dec. 16, 2010

(54) Radius Based Building Material Search System

(76) Inventor: Kathryn Quinn, Chicago, IL (US)

Correspondence Address: HURLEY STANNERS, LLC, 1011 LAKE STREET, OAK PARK, IL, 60301-1137, US

(21) Appl. No.: 12/485,069

(22) Filed: Jun. 16, 2009

(51) Int. Cl. G06F 17/30; G06F 7/00

(52) U.S. Cl. 707/769; 707/770; 707/791; 707/802; 707/803; 707/912; 707/955; 707/957; 707/812

(57) ABSTRACT

A method and system for conducting building material searches is disclosed. The system may include a radius-based search of local manufacturers through a comprehensive database of product and manufacturer information.

### FIELD OF THE INVENTION

The present invention relates generally to a method and system for conducting building material searches, and more specifically relates to a method and system for building material searches based on manufacturer's distances from a building site or other determined site, and a method of providing comprehensive manufacturer product information.

### BACKGROUND OF THE INVENTION

Contractors and construction companies depend on building material manufacturers for the completion of their projects. Construction costs can be reduced simply by buying materials of local manufacturers. Comprehensive and organized means of finding manufacturers and selecting products meeting specifications can also reduce building project costs. The Construction Specifications Institute (CSI) has taken steps toward this end by authoring the MasterFormat, a standardized system of 50 Divisions of construction. ARCAT, a directory of building material manufacturer information, includes these divisions.

Aside from direct savings, contractors may also pursue green initiatives through the use of energy saving or sustainable materials. The U.S. Green Building Council has developed the Leadership in Energy and Environmental Design (LEED) Green Building Rating System to promote efficient and environmentally effective design. The LEED system rates buildings on six major areas of “green” design, and Design Professionals, LEED Accredited Professionals and contractors may wish to pursue and search for materials crediting their project in these areas.

While search engines exist for building materials, none are as comprehensive as the present invention while possessing a radius-based search of local manufacturers.

### SUMMARY OF THE INVENTION

The present invention relates to one or more of the following features, elements or combinations thereof:

A comprehensive, radius-based building material search system is disclosed. In the preferred embodiment, companies or private individual users may access the search engine to customize a search of local material manufacturers. Users input the building material needed, location of their building project and specifies radius of search and the search engine provides manufacturer results with distances to each manufacturer. In addition to manufacturer locations, the database coupled to the search engine includes CSI divisions which can allow for a search that is industry specific as well as for general building material search. Searches may be customized to include and focus on any of this information.

### BRIEF DESCRIPTION OF THE DRAWINGS

FIG. 1 is a block flow diagram of a building material data retrieval system in accordance with one embodiment of the present invention; and

FIG. 2 is a screen shot of one embodiment of the search results that may be displayed while using the present invention.

### DETAILED DESCRIPTION OF EMBODIMENTS OF THE INVENTION

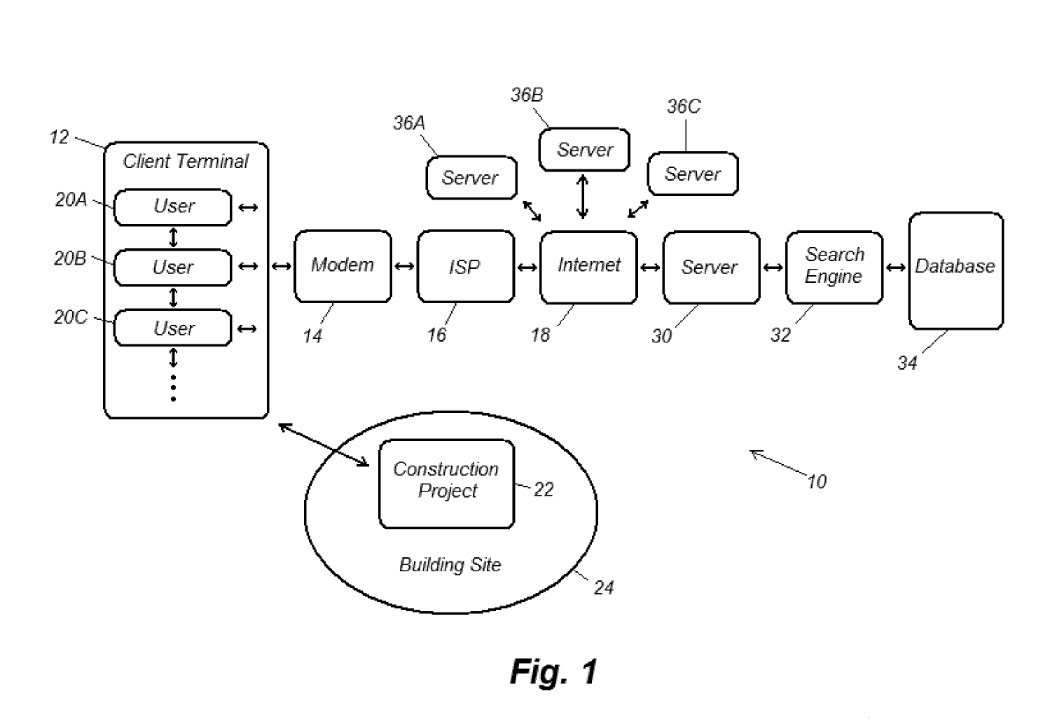

The preferred embodiment of the building material search system 10 is schematically depicted in FIG. 1. The system includes a client terminal 12 connected to the Internet 18 through a modem 14 and an Internet Service Provider (ISP) 16. The client terminal 12 may comprise any number of separate user terminals 20A-20C, each of which is a device, for example a personal computer, equipped with appropriate software for accessing, browsing, and retrieving World-Wide Web (www) resources on the Internet 18. Each such terminal is further capable of receiving input from and displaying information to the user operating the device. The client terminal accesses information regarding the construction project 22, which can be physically or hypothetically located at the building site 24.

Connection to the Internet 18 gives a user access to the server 30 for the building material search system. Server 30 illustratively includes a processor for processing data stored in the database and searching and arranging data in the database. The server 30 accesses a search engine 32 capable of searching and retrieving data from a database 34. The database illustratively includes comprehensive information regarding building material manufacturers and their products and CSI sections, potentially including manufacturer-supplied cost, LEED documents, and recycled content and location of material extraction, harvesting and recovering relative to manufacturer's location. The database may be continually updated from external directories such as ARCAT, and may be assigned attributes. A user may find materials based on any of this information in the database 34, either by selecting types of information from a list, or by inputting key words to begin a search. Any number of the types of information contained in the database 34 may be searched all at once or sequentially during a search to narrow down results. A material search may be coupled with input by a user regarding the location of the building site 24, for example in the form of a zip code, street address, or GPS location. This input may allow the search engine to conduct a radius-based search of building material manufacturers to report to the user the manufacturers' distances from the project site 24. It should be understood that building material suppliers, such as those with materials that have been reclaimed from other sites or other buildings. Accordingly, as used herein, the term “manufacturer” is intended to cover material suppliers as well.

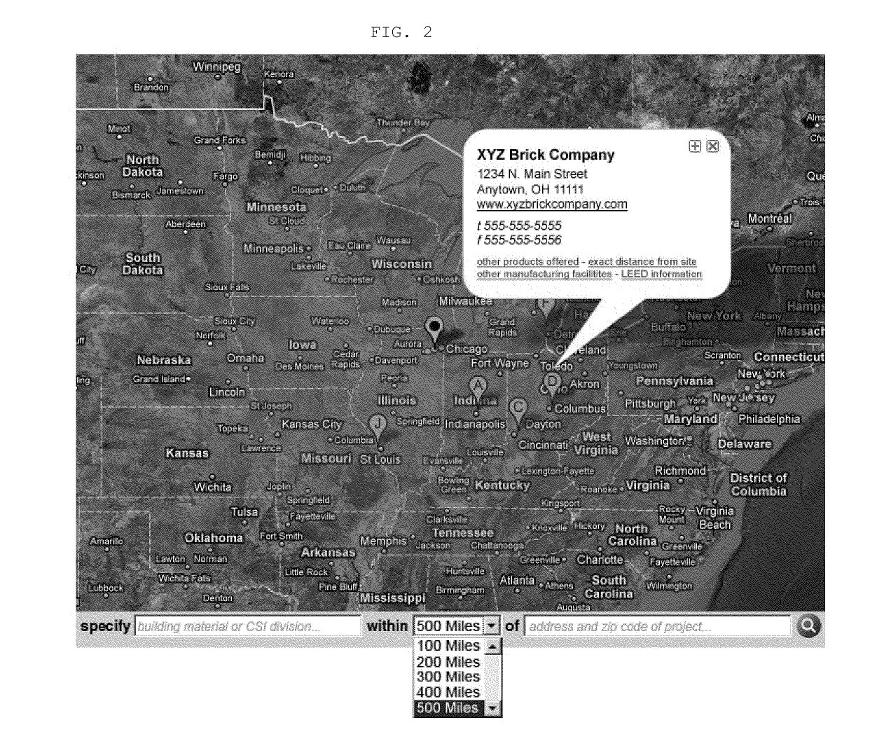

The search engine 32 can be customized to organize results according to user preferences of any of the database information, for example, by placing the closest manufacturers first in a list of results. The results can be returned in the form of a communicated message, such as a search results page, an e-mail, or any other fashion capable of providing the requested information organized in the requested manner. One embodiment of the communicated message can be viewed in FIG. 2.

The search engine user interface facilitates the purchase of building materials by the user. Product search results may be coupled with contact information or links to any number of the servers 36A-36C and corresponding web pages of the desired material manufacturers. Website revenue may be generated from searchable manufacturers in the form corporate sponsorship or fees for the display of company logos, or users may be charged for membership or on a per-use basis. Users may also save search results for later use.

While the disclosure is susceptible to various modifications and alternative forms, specific exemplary embodiments thereof have been shown by way of example in the drawings and have herein been described in detail. It should be understood, however, that there is not intent to limit the disclosure to the particular embodiments disclosed, but on the contrary, the intention is to cover all modifications, equivalents, and alternatives falling within the spirit and scope of the disclosure as defined by the appended claims.

What is claimed is:

1. A system for conducting building material searches, the system comprising:
a comprehensive database of building materials, building material manufacturers and building material manufacturer locations;
a processor capable of receiving input and using said input to organize and retrieve information from the database;
a user connected to the Internet capable of inputting data to and retrieving data from the processor, wherein the user can input information regarding a chosen location, and
wherein the processor uses the chosen location to calculate and create a message for the user, the message including distances to building material manufacturer locations.

2. The system of claim 1, wherein information in the database is organized and searchable by at least one product characteristic selected from the group consisting of: distance from chosen location and CSI Divisions.

3. The system of claim 2, wherein the user directs the search by selecting from among the available product characteristics.

4. The system of claim 2, wherein the search results are provided to the user in a fashion organized according to any of the product characteristics.

5. The system of claim 1, wherein the chosen location is a construction site.

6. The system of claim 1, wherein the chosen location is input in the form of a GPS location.

7. The system of claim 1, wherein the chosen location is input in the form of a street address.

8. The system of claim 1, wherein message can be saved by the user.

9. The system of claim 1, wherein the database is continually updated from external directories.

10. The system of claim 1, wherein message includes a link to manufacturer websites.

11. The system of claim 1, further comprising a method of providing the user with the ability to purchase products from the manufacturer.

12. A method of providing information related to building materials, the method comprising:
storing data in a database, the data comprising building material manufacturers, the manufacturers' products, and the manufacturers' locations;
providing a connection to the database through the Internet;
providing a search engine for searching the database;
providing a user with a way to input information into the search engine, such that a user can specify types of data to be searched;
determining a preferred location from which manufacturer locations can be calculated; and
providing results from the data searched.

13. The method of claim 12, wherein each item in the database is assigned at least one attribute selected from the group consisting of product location and CSI Division or building material name.

14. The method of claim 13, wherein the user directs the search according to at least one selected attribute of the group of attributes.

15. The method of claim 12, wherein the preferred location is a construction site.

16. The method of claim 12, wherein preferred location is determined by a user based on a street address.

17. The method of claim 12, wherein the preferred location is determined by a user based on a GPS location.

18. The method of claim 12, wherein results can be saved by the user.

19. The method of claim 12, wherein the results include a link to the manufacturers' websites.

20. The method of claim 12, wherein the method further comprises providing information related to purchasing building materials from a manufacturer
